(19) United States
(12) Patent Application Publication
(10) Pub. No.: US 2026/0126258 A1
(43) Pub. Date: May 7, 2026

(54) VR TRIGGER CONTROL DEVICE TO PLACE INSIDE A GUN

(71) Applicant: GAIM IMMERSIVE TECHNOLOGY GROUP AB, MALMÖ (SE)

(72) Inventors: Stephan ESKILANDER, LUND (SE); Tobias HÖRNGREN, LOMMA (SE); Oscar BORG, LIMHAMN (SE)

(73) Assignee: GAIM IMMERSIVE TECHNOLOGY GROUP AB, MALMÖ (SE)

(21) Appl. No.: 19/119,255

(22) PCT Filed: Nov. 10, 2023
(86) PCT No.: PCT/SE2023/051140

§ 371 Date: Apr. 8, 2025

(30) Foreign Application Priority Data
Nov. 11, 2022 (SE) 2251326-1

(51) Int. Cl. F41A 33/00; A63F 13/245; A63F 13/837; F41A 19/10; F41A 19/15; F41B 11/71

(52) U.S. Cl. CPC F41A 33/00; A63F 13/245; F41A 19/10; F41A 19/15; F41B 11/71; A63F 13/837

(57) ABSTRACT

A virtual reality, VR, trigger control device for various guns, comprising a casing containing a Bluetooth device and a trigger mechanism with a trigger protruding from a plane side of the casing, wherein said Bluetooth device is configured to detect a trigger output signal generated by the trigger mechanism in response to the trigger being pulled and to send a wireless event signal in response to the detected trigger output signal to a VR headset.

### TECHNICAL FIELD

The present disclosure relates to a virtual reality, VR, trigger control device, and more particularly, to a VR trigger control device for various guns.

### BACKGROUND

Shooting simulators have been provided for shooting practice for home or other indoor training where shooters can fire simulated projectiles against simulated targets to improve targeting and shooting techniques for hunters and sportsmen. Different types of prior art target practice and aiming devices have been suggested to simulate the firing of a weapon.

A prior art virtual reality, VR, hunting and shooting simulator for training shooting in immersive environments, comprises a virtual reality (VR) rifle and associated software modules provided by the Applicant, and a VR headset and a VR tracker. The VR headset is configured for tracking the VR tracker. The VR rifle is equipped with a trigger unit specifically adapted for and fixedly mounted to the stock of the VR rifle. The trigger unit is adapted to detect or sense an electrical signal indicative of an event signal generated in response to the trigger has been pulled, and to send a corresponding event signal to the VR headset.

Although, the VR rifle of the Applicant provide a reliable and durable shooting simulator system as well as a realistic user experience, the user of the simulator system is confined to a particular VR rifle.

US2017307333 describes a system and method for simulating lead of a target including a network, a simulation administrator connected to the network, a database connected to the simulation administrator, and a user device connected to the network. The user device includes a set of virtual reality unit, and a computer connected to the virtual reality unit and to the network. A set of position trackers are connected to the computer. A trigger unit including a paddle is secured to the exterior of a weapon with fasteners used with the simulation system. Upon deflection of the paddle, the trigger unit sends electric signals utilized by the system. The trigger unit is in electronic communication with a simulation computer using a short range wireless communications protocol, such as Bluetooth. A positioning detector is fitted to the muzzle on the barrel of the weapon. This rather complex arrangement may be used with different kinds och rifles or shotguns but provides an unrealistic experience for the user and may easily break.

US2019353457A1 describes a system and method for marksmanship training comprising a trigger sensor contoured to fit onto the back end of the trigger guard behind the trigger and a trigger sensor is secured onto the trigger guard by small screws. The trigger sensor detects the pull of the trigger when the trigger presses onto a pressure switch with sufficient movement and force. However, it is a fiddly job to mount and release the small pieces and screws of the trigger sensor to/from the trigger guard. Further, this sensor has sharp edges, on which the shooter can injure during himself during use.

Accordingly, a more flexible and user friendly VR trigger device for various guns of VR shooting simulator system providing a realistic user experience is desirable in the art.

### SUMMARY

It is an object of the teachings of this application to obviate at least some of the disadvantages discussed above, and to offer improvements in the technical field of VR trigger units.

In accordance with one aspect of the present disclosure, this is achieved by a virtual reality, VR, trigger control device for various guns, comprising a casing containing a Bluetooth device and a trigger mechanism with a trigger protruding from a plane side of the casing, wherein said Bluetooth device is configured to detect a trigger output signal generated by the trigger mechanism in response to the trigger being pulled and to send a wireless event signal in response to the detected trigger output signal to a VR headset.

In some embodiments, the casing may have a recess in an edge forming an indentation of the casing so as to cooperate with a complementary surface inside a receiver of a real handgun, dummy weapon, VR game gun, VR trigger control device holder for a real firearm or rifle stock, a magazine box of a real gun, receiver of an automatic carbine, or receiver of an airgun, soft air gun, or airsoft gun.

In some embodiments, the casing may have a notch in an outside surface of the casing adapted to receive a latch pin for locking the VR trigger control device in place inside the gun.

In some embodiments, the casing comprises a top surface, a bottom surface, a back surface, a front surface, a left side plate, and a right side plate forming a rectangular casing surrounding the Bluetooth device and the trigger mechanism.

In some embodiments, the recess is arranged in the edge connecting the bottom surface and the back surface of the casing.

In some embodiments, the notch is arranged in the back surface of the casing.

In some embodiments, one or more of the top surface, bottom surface, back surface, front surface of the casing have one or more grooves for receiving corresponding tenons of a VR trigger control device holder.

In some embodiments, the trigger mechanism comprises an adjustment screw arranged for adjustment of a trigger release distance accessible from the exterior of the VR trigger control device.

In some embodiments, the VR trigger control device comprises at least one electrical connector of the Bluetooth device for operatively connection to an electrical cartridge a gun.

In some embodiments, the Bluetooth device is adapted to detect or sense an electrical signal at the at least one electrical connector indicative of a shot signal generated in response to the electrical cartridge being activated and send a corresponding shot signal to the VR headset.

The Bluetooth device may comprise a processor operatively connected to a memory, a battery, and an antenna, wherein the processor is configured to execute program instructions stored in the memory causing the Bluetooth device to detect the trigger output signal generated by the trigger mechanism in response to the trigger being pulled and to send the wireless event signal in response to the detected trigger output signal to the VR headset to cause an augmented reality or virtual reality event on an augmented reality or virtual reality display.

The gun may be a rifle stock, real firearm, real handgun, real automatic carbine, airgun, soft air gun, airsoft gun, VR game gun or dummy weapon.

According to a second aspect, a VR trigger control device holder for removably attach a VR trigger control device to a rifle stock is provided. The holder comprises a rigid frame adapted to surround and removably hold the VR trigger control device firmly within the rigid frame, wherein the rigid frame has trigger guard for surrounding the trigger and at least a protrusion inside the ridged frame so as to cooperate with a complementary indentation of the casing of the VR trigger control device.

In some embodiments, the rigid frame may have one or more tenons adapted to fit into corresponding grooves of the casing for holding the VR trigger control device in place.

In some embodiments, the rigid frame may have screw holes on both sides of the trigger guard for securing the VR trigger control device holder to the rifle stock.

According to a third aspect, a VR trigger device holder interface for removably attach a VR trigger control device to a real firearm is provided, wherein the holder interface comprises an openable casing including two separate and complementary parts for enclosing the VR trigger control device with the trigger protruding through an aperture of the openable casing.

In some embodiments, the VR trigger device holder interface may comprise at least one exterior electrical connector for connection to an electrical cartridge of a firearm, and at least one interior electrical connector arranged inside the openable casing for connection to the at least one electrical connector of the Bluetooth device of the VR trigger control device, wherein the at least one interior electrical connector is operatively connected to the at least one exterior electrical connector, wherein the Bluetooth device is adapted to detect or sense an electrical signal, indicative of a shot signal generated in response to the electrical cartridge being activated.

In some embodiments, the VR trigger device holder interface may comprise a tracker holder for a VR tracker attached on top of the holder interface.

According to a forth aspect, a magazine box for removably attach a VR trigger control device to a real firearm is provided, wherein the magazine box is adapted to receive and removably hold the trigger control device, wherein the magazine box has trigger guard for surrounding the trigger and a protrusion inside the magazine box so as to cooperate with a complementary indentation of the casing of the VR trigger control device.

An advantage of some embodiments of the present disclosure is an improved VR trigger control device which may be use with various guns of VR shooting simulator system providing a realistic user experience.

Another advantage of some embodiments of the present disclosure is an improved VR trigger control device, which may be easily assembled with and disassembled from different kinds of guns, such a a rifle stock, real firearm, real handgun, real automatic carbine, airgun, soft air gun, airsoft gun, VR game gun, or dummy weapon.

Still another advantage of some embodiments, is that the notch of the VR trigger control device and the cooperating latch pin of the gun prevents the VR trigger control device from rising from its position when the trigger is pressed.

Other aspects and features of the invention and its embodiments are defined by the appended patent claims and are further explained, together with problems solved and advantages obtained, in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof.

All terms used in the claims are to be interpreted according to their ordinary meaning in the technical field, unless explicitly defined otherwise herein. All references to “a/an/the element, device, component, means, etc are to be interpreted openly as referring to at least one instance of the element, device, component, means, etc., unless explicitly stated otherwise.

### BRIEF DESCRIPTION OF THE DRAWINGS

Exemplary embodiments are illustrated by way of example in the accompanying drawings in which like reference numbers indicate the same or similar elements and in which:

FIG. 1A is a right side view of a virtual reality (VR) trigger control device according to an embodiment;

FIG. 1B is a front view of the VR trigger control device as shown in FIG. 1A; FIG. 1C is a left side view of the VR trigger control device as shown in FIG. 1A;

FIG. 2 is a block diagram of a Bluetooth device according to an embodiment and a VR headset;

FIG. 3A is a right side view of a real gun and the VR trigger control device as shown in FIG. 1A;

FIG. 3B is a right side view of the real gun arranged with the VR trigger control device of FIG. 3A;

FIG. 4 is a locally enlarged view of a latch pin of the real gun for locking the VR trigger control device as shown in FIG. 3B;

FIG. 5 is perspective view of a VR trigger control device holder for the VR trigger control device of FIG. 1A;

FIG. 6 is perspective view of a VR trigger device kit with the VR trigger control device of FIG. 1A inserted into the holder of FIG. 5;

FIG. 7 is a right side view of a rifle stock with the VR trigger device kit as shown in FIG. 6;

FIG. 8 schematically depicts a shooting simulator system including the rifle stock of FIG. 7 with a mounted VR trigger device kit of FIG. 6;

FIG. 9A is a perspective view of a VR trigger device holder interface for a VR trigger control device in an open position to receive the VR trigger control device in FIG. 1A;

FIG. 9B is a perspective view of the holder interface of FIG. 9A in a closed position containing the VR trigger control device in FIG. 1A;

FIG. 9C is schematic right side view of the holder interface if FIG. 9B attached to a barrel of a rifle provided with an electrical cartridge for a shooting simulator system; and

FIG. 10 schematically depicts various guns for use with the VR trigger control device of FIG. 1A.

### DESCRIPTION OF EMBODIMENTS

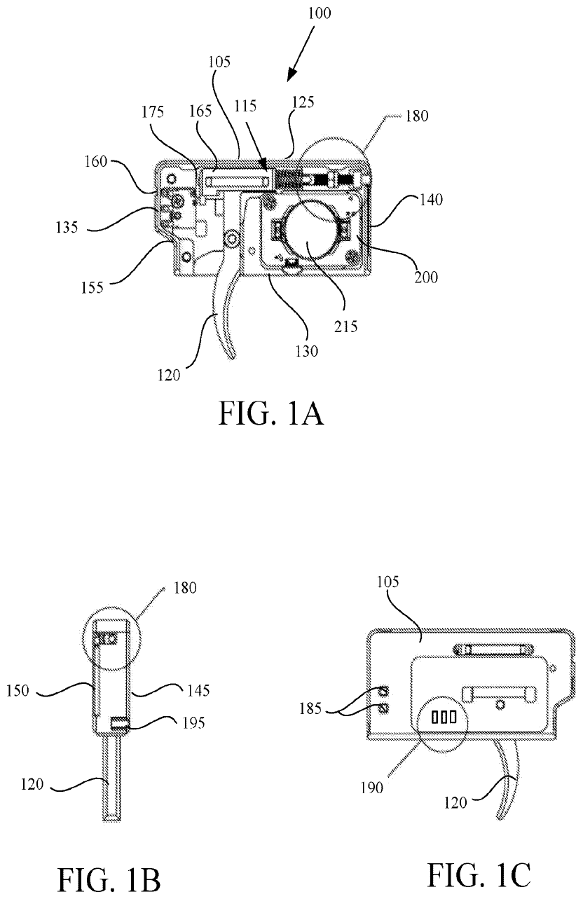

Embodiments of the invention will be described with reference to FIGS. 1-10, which all illustrate schematically example arrangements according to some embodiments of the invention. Any equivalent variation and modification made according to appended claims is covered by the claims.

Reference will now be made to the figures to describe the embodiments in detail. The same reference signs are used for corresponding features in different figures.

Spatial and orientation terms, such as “below,” “lower,” “above,” “upper,”, “on top of” and the like, may be used herein for ease of description to describe one feature's or element's relationship to another feature(s) or element(s) as illustrated in the figures. Moreover, the spatially relative terms are intended to encompass different orientations of a device in use or operation in addition to the orientation depicted in the figures. Moreover, terms such as “top surface”, “bottom surface”, “back surface”, “front surface”, “left side”, “right side” of a device generally relates to the position of different parts of the device when used in normal operation. For example, a marksman or user of a firearm, such as a hunting rifle, handgun, or VR game gun, is positioned behind and holding the rifle stock or pistol grip while pointing the muzzle, i.e the front end of the barrel, in a direction of an intended target.

Reference is generally made to FIGS. 1A, 1B, and 1C which show a virtual reality (VR) trigger control device 100 according to an embodiment. The VR trigger control device 100 is arranged to be attached or mounted in a gun for use in combination with a VR shooting simulator system. As used herein, the term “gun” includes, but is not limited to, a real gun, firearm, weapon, rifle, such a hunting rifle, repeating rifle, shotgun, automatic or semi-automatic rifle, small firearm, such as a handgun or pistol, or a VR game gun or dummy weapon.

As illustrated in FIG. 1A-1C, the VR trigger control device 100 comprises a casing 105 including, i.e containing, a Bluetooth device 200 and a trigger mechanism 115 including a trigger 120. In this embodiment, a top surface 125, a bottom surface 130, a back surface 135, a front surface 140, a left side plate 145, and a right side plate 150 forming a rectangular casing surrounding the Bluetooth device 200 and the trigger mechanism 115. The trigger 120 is arranged to protrude from a plane side, preferably the bottom surface 130 of the casing 105.

The casing may have a recess 155 in an edge forming an indentation of the casing 105, so as to cooperate with a complementary surface of a receiver, frame, holder, or magazine box of a gun. In this embodiment, the recess 155 is, advantageously, arranged in an edge connecting the bottom surface 130 and the back surface 135. However, in another embodiment, the recess may be arranged in an edge connecting the bottom surface 130 and the front surface 140.

In an embodiment, the recess 155 is arranged to cooperate with a complementary rest surface of a receiver, frame, holder, or magazine box of a gun for holding the VR trigger control device 100 in place within the interior of the gun.

Moreover, the casing 105 may have a notch 160 provided in an outside surface of the casing 105 adapted to receive a latch pin for locking the VR trigger control device in place inside the gun. In this embodiment, the notch 160 is, advantageously, arranged in an upper portion of the back surface 135 of the casing 105, thereby also preventing the VR trigger control device from rising from its position when the trigger is pressed. In another embodiment, the notch may be arranged in the front surface 140 of the casing 105.

The trigger mechanism 115 is arranged to generate a trigger output signal in response the trigger 120 being pulled. In this embodiment, the trigger mechanism 115 comprises, but is not limited to, a trigger magnet 165 arranged with magnetic force on top of the trigger 120. A front end of the magnet 165 is in contact with a trigger spring 170 and a back end of the magnet 165 is directed to a contact pad 175 of the VR trigger control device. When a user presses the trigger 115, the trigger magnet 165 is forced against the trigger spring 170 until the trigger magnet is released, wherein the trigger magnet is forced in contact with the contact pad 175 by means of the trigger spring 170. When the back end of the trigger magnet 165 hits the contact pad 175, a trigger output signal is generated, which is detected by the Bluetooth device 200. In this embodiment, the trigger output signal may be an electrical signal. However, in other embodiments, the trigger output signal may be a magnetic signal, or an acoustic signal detectable by a corresponding sensor of the Bluetooth device.

Moreover, the trigger mechanism 115 may be provided with an adjustment screw 180 for adjustment of a trigger release distance of the VR trigger control device 100. As illustrated in FIG. 1B, the trigger adjustment screw 180 is arranged to be accessible from the exterior of the casing 105 of the VR trigger control device 100.

In one embodiment, the VR trigger control device 100 may have at least one electrical connector or contact pad 185 of the Bluetooth device 200 for operatively connection to an electrical cartridge of a gun. Further, the Bluetooth device 200 is adapted to detect an electrical signal at the at least one electrical connector or contact pad 185 indicative of an event signal, for example a shot signal generated in response to activation of the electrical cartridge, i.e when the gun is fired.

In addition, the VR trigger control device 100 may have a LED array 190 responsive to different operational modes of the Bluetooth device 200.

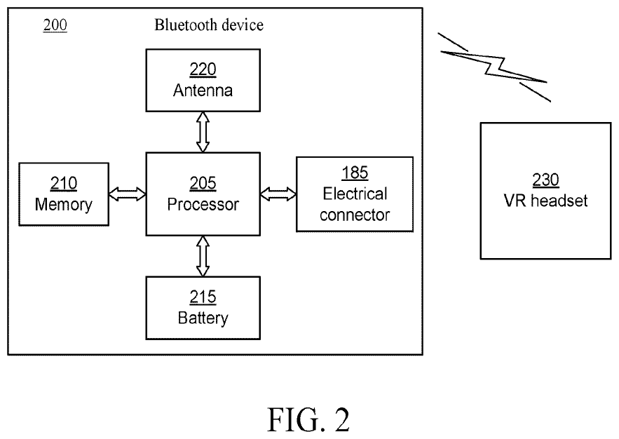

As illustrated in FIG. 2, the Bluetooth device 200 comprises a printed circuit board (PCB) including a processor 205, for example a microprocessor, operatively connected to a memory 210, a battery 215, and an antenna 220. The processor 205 is configured to execute program instructions stored in the memory 210 causing the Bluetooth device 200 to detect the trigger output signal generated by the trigger mechanism 115 in response to the trigger 120 being pulled. Further, the Bluetooth device 200 is adapted to send a wireless event signal in response to the detected trigger output signal to a paired VR headset 230 to cause an augmented reality or virtual reality event on an augmented reality or virtual reality display of the VR headset 230.

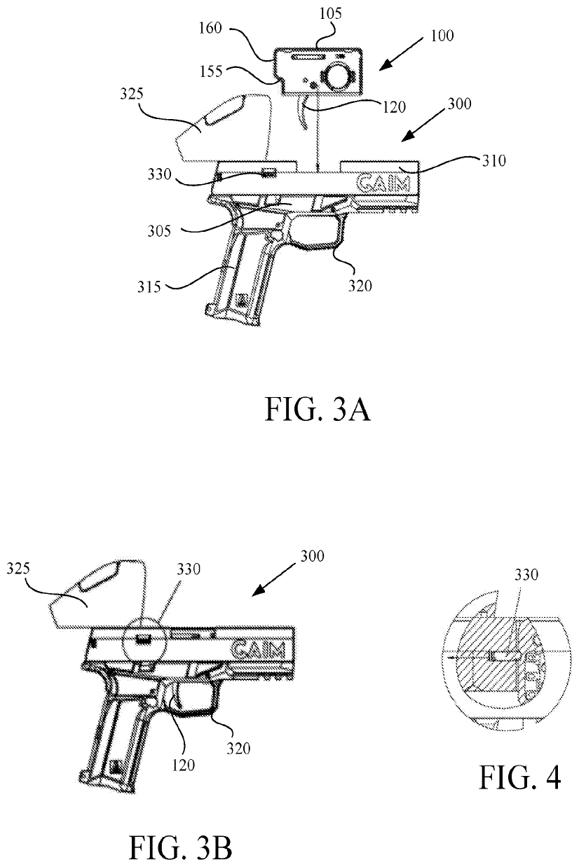

Referring generally to FIGS. 3A-3C, component parts of real handgun 300 comprises a receiver or frame 305, a slide 310, a grip 315, and a trigger guard 320. As illustrated in FIG. 3A, the VR trigger control device 100 is about to be inserted from above the handgun 300 into the receiver 305 via an opening in the proximal part of the slide 310. In this embodiment, a tracker holder 325 for a VR positioning detector or tracker is attached above the grip 315 on top of the slide 310.

In FIG. 3B, the VR trigger control device 100 has been inserted into the handgun 300, wherein the recess 155 of the casing 105 cooperates with a complementary surface, such as a top surface of a magazine, inside the receiver 305. In this embodiment of the handgun 300, the receiver slide 310 is provided with a latch pin 330 arranged to engage the notch 160 of the back surface of the casing 105, thereby locking the VR trigger control device 100 inside the handgun.

As illustrated in further detail in FIG. 4, the latch pin 330 may be moved backwards for releasing the VR trigger control device 100, which may be easily separated from the gun 300. Thereby, the VR trigger control device 100 may be moved to and inserted into, i.e assembled with, another similar or different gun, or just stored for future use.

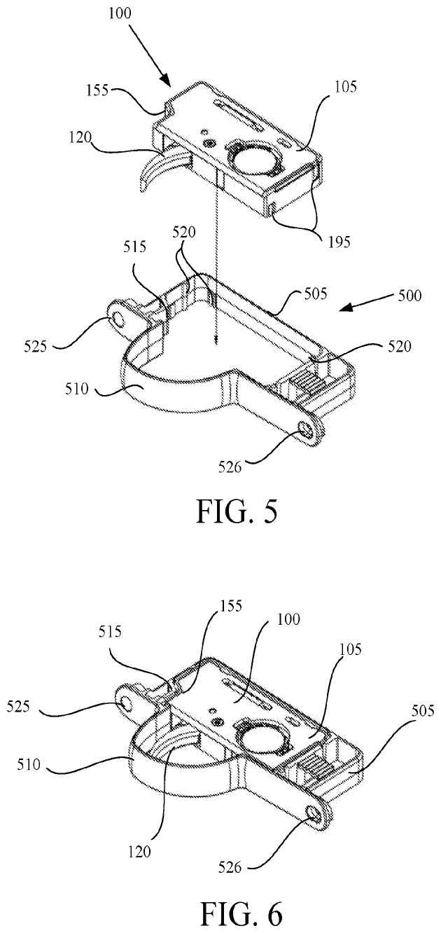

Referring now to FIG. 5, a VR trigger control device holder 500 for removably attach a VR trigger control device 100 to a rifle stock, comprises a rigid frame 505 adapted to surround and removably hold the VR trigger control device 100 firmly within the frame. The holder may be made of, but is not limited to, plastic or aluminium or any other suitable material for providing a rigid frame. The frame 505 has a trigger guard 510 for surrounding the trigger 120. Further, the holder 500 has a protrusion 515 inside the frame 505, so as to cooperate with the complementary indentation or recess 155 of the casing 105 when the VR trigger control device 100 is inserted into the holder 500.

In this embodiment, the holder 500 have one or more projections or tenons 520 adapted to fit into corresponding grooves 195 of the casing 105 for aligning and holding the VR trigger control device 100 in place in the holder 500. Advantageously, the joints between the tenons 520 and grooves 195 prevent the VR trigger control device 100 from being pushed out from the frame by mistake of user.

The rigid frame 505 is provided with screw holes 525, 526 through elongated portions on both sides of the trigger guard 510 for securing the VR trigger control device holder 500 when it is inserted into a rifle stock.

In FIG. 6, the VR trigger control device 100 has been inserted and assembled with the holder 500 forming a VR trigger device kit, wherein the recess 155 of the casing 105 cooperates with the complementary surface of the protrusion 515 inside the frame 505. The tenons 520 of the frame 500 fits into the corresponding grooves 195 of the casing 105, thereby holding the VR trigger control device 500 in place within the holder 500. In this embodiment, the VR trigger control device may have a plane back surface without a notch.

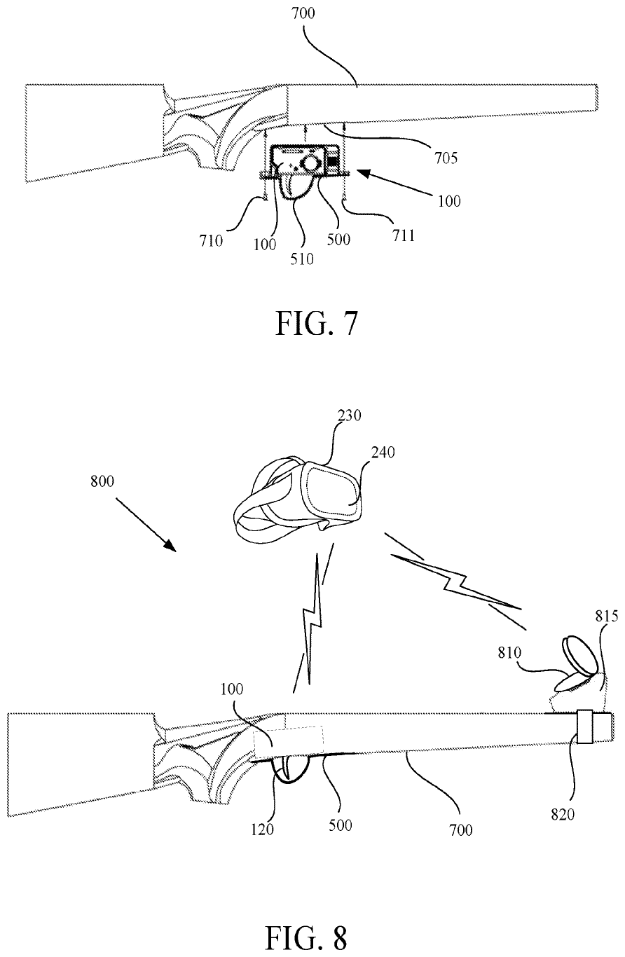

Referring now to FIG. 7, the VR trigger control device 100 and the holder 500 of the kit is positioned below a rifle stock 700 for insertion into a hollow space 705 within the rifle stock. The with the holder 500 and the VR trigger control device 100 may be securely attached to the rifle stock 700 preferably by means of screws 710, 711 through the screw holes of the elongated trigger guard 510.

Similarly, the complete kit with the holder 500 with the VR trigger control device 100 may be easily removed from the rifle stock 700 by loosen the screws 710, 711.

The kit with the holder 500 and the VR trigger control device 100 may in turn be easily disassembled by a user manually forcing out the VR trigger control device 100 from the holder 500 by detaching the tenons 520 from the grooves 195. Thereby, the VR trigger control device 100 may be inserted into, i.e assembled with, another holder or inserted into another gun.

Reference is made to FIG. 8, which is a perspective view of a VR shooting simulator system 800 including the VR headset 230, a VR tracker or positioning detector 810, and the rifle stock 700. The positioning detector 810 may be arranged in a VR tracker holder 815, which may be attached to the rifle stock 700 by means of a fastener or strap 820. The kit with the VR trigger control device holder 500 and the VR trigger control device 100 is securely attached to the rifle stock by the screws 710, 711.

As describe above in connection with FIG. 2, the processor 205 of the VR trigger control device 100 is configured to execute program instructions stored in the memory 210 causing the Bluetooth device 200 to detect the trigger output signal generated by the trigger mechanism 115 in response to the trigger 120 being pulled.

Further, the Bluetooth device is configured to send a wireless event signal in response to the detected trigger output signal to the paired VR headset 230 to cause an augmented reality or virtual reality event on an augmented reality or virtual reality display 240 of the VR headset 230.

The VR shooting simulator system 800 may be configured to simulate different kind of shooting scenarios including but not limited to, virtual hunting, marksmanship, skeet, trap, sporting clay shooting, bird or game shooting or any other virtual shooting environment.

The VR headset 230 may be, but is not limited to, the Pico Neo 3 pro/Pro Eye developed by Pico Immersive Pte. Ltd, the Oculus Quest 2 VR headset developed by Oculus, the HTC Vive Focus 3 headset available from HTC Corporation, or any augmented or virtual reality headset or unit in the art providing inside-out tracking, to immerse the shooter in a virtual hunting, marksmanship, skeet, trap, sporting clay shooting, bird or game shooting or any other virtual shooting environment. The VR headset 230 may be a standalone device that can run games and software wirelessly under an Android-based operating system or any other suitable operating system.

Still referring to FIG. 8, the positioning detector 815 may be, but is not limited to, an Oculus Touch controller configured to execute instructions causing the positioning detector 815 to continuously measure or track its position and orientation using its sensors and to broadcast its position and orientation. The positioning detector 815 may communicate over a short range wireless connection, such as Bluetooth, to the VR headset 230.

Thereby, the VR shooting simulator system 800 may be configured to detect or sense a trigger output signal indicative of a shot signal or an event signal generated in response to that the trigger 120 of the VR trigger control device 100 has been pulled in different kind of simulated shooting scenarios including but not limited to, virtual hunting, marksman-ship, skeet, trap, sporting clay shooting, bird or game shooting or any other virtual shooting environment.

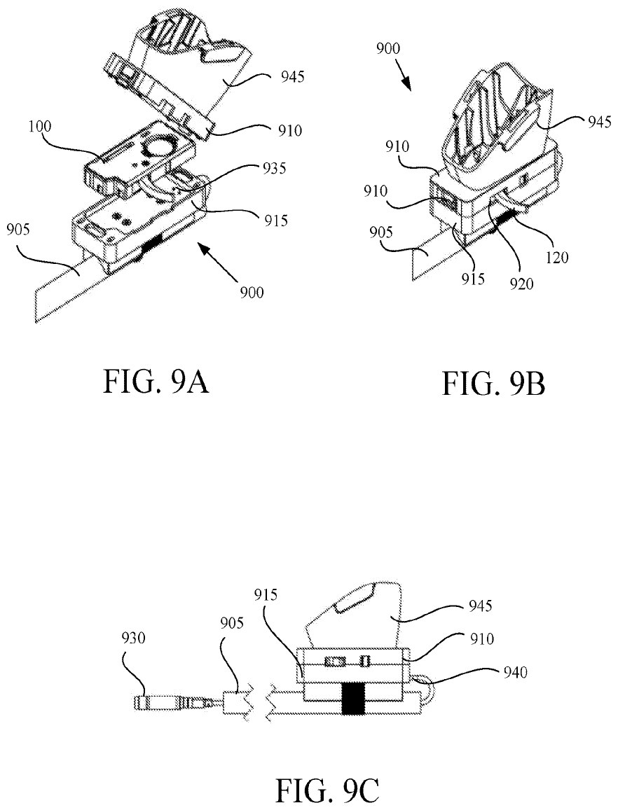

Referring generally to FIGS. 9A-9C, a VR trigger device holder interface 900 for removably attach the VR trigger control device 100 to a barrel 905, preferably near the muzzle of a real firearm, for example a hunting rifle, comprises an openable casing including two separate and complementary first and second interface parts 910, 915 for enclosing the VR trigger control device 100 with the trigger 120 protruding through an aperture 920 of the openable casing.

The holder interface 900 comprises at least one exterior electrical connector 925 for connection to an electrical cartridge 930 of the firearm, and at least one interior electrical connector 935, for example one or more pogo pins, arranged inside the openable casing for connection to the at least one electrical connector or contact pad 185 of the Bluetooth device 200 of the VR trigger control device 100. The at least one interior electrical connector 935 is operatively connected to the at least one exterior electrical connector 940. Moreover, holder interface 900 is provided with a tracker holder 945 for a VR positioning detector attached on top of the holder interface 900.

In this embodiment, the Bluetooth device 200 of the VR trigger control device 100 is configured to detect or sense an electrical signal at the connector 185 indicative of a shot signal generated in response to that the electrical cartridge 120 has been activated, and to send a corresponding shot signal via the antenna 220 to the VR headset 230. Hence, a shooting simulator system including the real firearm provided with the holder interface 900 may be configured to detect or sense an electrical signal indicative of a shot signal generated in response to that the electrical cartridge 930 has been activated in response to a pulled trigger of the firearm and the electrical cartridge is activated, i.e fired, in different kind of simulated shooting scenarios including but not limited to, virtual hunting, marksman-ship, skeet, trap, sporting clay shooting, bird or game shooting or any other virtual shooting environment. Additionally, the trigger 120 may still be used to generate event signals for operating the VR shooting simulator system.

The features and advantages of the invention are apparent from the detailed specification, and thus it is intended by the appended claims to cover all such features and advantages of the invention, which fall within the scope of the technology. For example, the detectable output signal generated in response to the trigger being pulled by a user of the firearm of the shooting simulator system may be used for controlling different functions of the simulation system, for example, but not limited to, simulating a firing or selecting different menu items in different kind of simulated shooting scenarios including but not limited to, virtual hunting, marksmanship, skeet, trap, sporting clay shooting, bird or game shooting or any other virtual shooting environment.

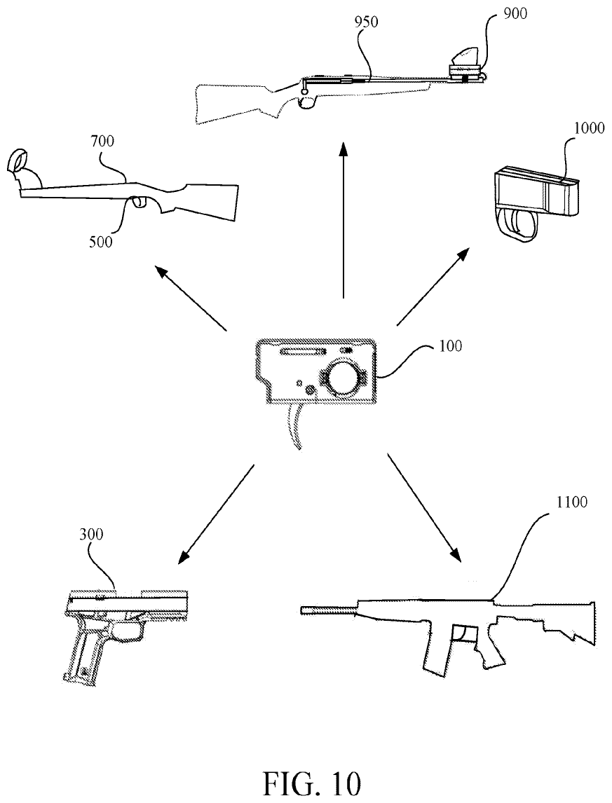

FIG. 10 schematically depicts various guns, including but not limited to a real pistol 300, the rifle stock 700, a real rifle 950, a magazine box 1000 for a real gun, and real automatic carbine 1100, for use with the VR trigger control device 100. Likewise, the VR trigger control device 100 may be used with a VR game gun or dummy weapon.

Other configurations are possible within the scope of the present patent claims. However, although embodiments of the VR trigger control device and shooting simulator system have been illustrated in the accompanying drawings and described in the foregoing detailed description, the disclosure is illustrative only, and changes, modifications and substitutions may be made without departing from the scope of the technology as set forth and defined by the following claims.

Hence, it should be understood that the limitations of the described embodiments are merely for illustrative purpose and by no means limiting. Instead, the scope of the technology is defined by the appended claims rather than by the description, and all variations that fall within the range of the claims are intended to be embraced therein.

In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

### List of Reference Numbers

100 VR trigger control device
105 casing
110 Bluetooth device
115 trigger mechanism
120 trigger
125 top surface
130 bottom surface
135 back surface
140 front surface
145 left side plate
150 right side plate
155 recess
160 notch
165 trigger magnet
170 trigger spring
175 contact pad
180 adjustment screw
185 electrical connector
190 LED array
195 grooves
200 Bluetooth device
205 processor
210 memory
215 battery
220 antenna
230 VR headset
300 handgun
305 receiver, frame
310 slide
315 grip
320 trigger guard
325 tracker holder
330 latch pin
500 VR trigger control device holder
505 rigid frame
510 trigger guard
515 protrusion
520 tenon
525 screw hole
526 screw hole
700 rifle stock
705 hollow space
710 screw
711 screw
800 VR shooting simulator system
810 VR tracker
815 VR tracker holder
820 strap
900 VR trigger device holder interface
905 barrel
910 first interface part
915 second interface part
920 aperture 920
930 electrical cartridge
935 interior electrical connector
940 exterior electrical connector

1. A virtual reality, VR, trigger control device for various guns,
comprising a casing containing a Bluetooth device and a trigger mechanism with a trigger protruding from a plane side of the casing, wherein said Bluetooth device is configured to detect a trigger output signal generated by the trigger mechanism in response to the trigger being pulled and to send a wireless event signal in response to the detected trigger output signal to a VR headset wherein said casing has a recess in an edge forming an indentation of the casing so as to cooperate with a complementary surface inside a receiver of a real handgun, dummy weapon, VR game gun, a VR trigger control device holder for a real firearm or rifle stock, a magazine box of a real gun, receiver of an automatic carbine, or receiver of an airgun, soft air gun, or airsoft gun, or inside a VR trigger device holder interface.

2. (canceled)

3. The VR trigger control device according to claim 1,
wherein the casing has a notch in an outside surface of the casing adapted to receive a latch pin for locking the VR trigger control device in place inside the gun.

4. The VR trigger control device according to claim 3,
wherein the casing comprises a top surface, a bottom surface, a back surface, a front surface, a left side plate, and a right side plate forming a rectangular casing surrounding the Bluetooth device and the trigger mechanism.

5. The VR trigger control device according to claim 4,
wherein the recess is arranged in the edge connecting the bottom surface and the back surface of the casing.

6. The VR trigger control device according to claim 4,
wherein the notch is arranged in the back surface of the casing.

7. The VR trigger control device according to claim 4,
wherein one or more of the top surface, bottom surface, back surface, front surface of the casing have one or more grooves for receiving corresponding tenons of a VR trigger control device holder.

8. The VR trigger control device according to claim 1,
wherein the trigger mechanism comprises an adjustment screw arranged for adjustment of a trigger release distance accessible from the exterior of the VR trigger control device.

9. The VR trigger control device according to claim 1, comprising at least one electrical connector of the Bluetooth device for operatively connection to an electrical cartridge of a gun.

10. The VR trigger control device according to claim 9,
wherein the Bluetooth device is adapted to detect or sense an electrical signal at the at least one electrical connector indicative of a shot signal generated in response to the electrical cartridge being activated and send a corresponding shot signal to the VR headset.

11. The VR trigger control device according to claim 1,
wherein the Bluetooth device comprises a processor operatively connected to a memory, a battery, and an antenna, wherein the processor is configured to execute program instructions stored in the memory causing the Bluetooth device to detect the trigger output signal generated by the trigger mechanism in response to the trigger being pulled and to send the wireless event signal in response to the detected trigger output signal to the VR headset to cause an augmented reality or virtual reality event on an augmented reality or virtual reality display.

12. The VR trigger control device according to claim 1,
wherein the gun is a rifle stock, real firearm, real handgun, real automatic carbine, airgun, soft air gun, airsoft gun, or VR game gun.

13. A VR trigger control device holder for removably attaching a VR
trigger control device according to claim 1 to a rifle stock,
wherein the holder comprises a rigid frame adapted to surround and removably hold the VR trigger control device firmly within the rigid frame, wherein the rigid frame has trigger guard for surrounding the trigger and at least a protrusion inside the ridged frame so as to cooperate with the complementary indentation of the casing of the VR trigger control device.

14. The VR trigger control device holder according to claim 13,
wherein the rigid frame have one or more tenons adapted to fit into corresponding grooves of the casing for holding the VR trigger control device in place.

15. The VR trigger control device holder according to claim 13,
wherein the rigid frame has screw holes on both sides of the trigger guard for securing the VR trigger control device holder to the rifle stock.

16. A VR trigger device holder interface for removably attaching a VR trigger control device according to claim 1 to a real firearm,
wherein the holder interface comprises an openable casing including two separate and complementary parts for enclosing the VR trigger control device with the trigger protruding through an aperture of the openable casing.

17. The VR trigger device holder interface of claim 16, comprising at least one exterior electrical connector for connection to an electrical cartridge of a firearm, and at least one interior electrical connector arranged inside the openable casing for connection to the at least one electrical connector of the Bluetooth device of the VR trigger control device wherein the at least one interior electrical connector is operatively connected to the at least one exterior electrical connector, wherein the Bluetooth device is adapted to detect or sense an electrical signal, indicative of a shot signal generated in response to the electrical cartridge being activated.

18. The VR trigger device holder interface according to claim 16, comprising a tracker holder for a VR tracker attached on top of the holder interface

19. A magazine box for removably attaching a VR trigger control device according to claim 1 to a real firearm,
wherein the magazine box adapted to receive and removably hold the trigger control device, wherein the magazine box has trigger guard for surrounding the trigger and a protrusion inside the magazine box so as to cooperate with a complementary indentation of the casing of the VR trigger control device.
